(19) United States
(12) Patent Application Publication
(10) Pub. No.: US 2006/0044401 A1
(43) Pub. Date: Mar. 2, 2006

(54) Mobile communication terminal for storing a picture and picture-taking location information and method for providing services using the same

(75) Inventor: Hyung-Weon Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/151,328

(22) Filed: Jun. 13, 2005

(30) Foreign Application Priority Data
Aug. 31, 2004 (KR) 69190/2004

(51) Int. Cl. H04N 5/225

(52) U.S. Cl. 348/207.99

(57) ABSTRACT

A mobile communication terminal including a Global Positioning System (GPS) reception unit for receiving a GPS signal. A camera unit takes a picture in response to input of a picture-taking request signal. A memory unit stores the taken picture and picture-taking location information. A control unit generates the picture-taking location information using the GPS signal, and controls an operation for storing the taken picture and the generated picture-taking location information together. The mobile communication terminal stores a picture of a predetermined place and picture-taking location information, such that a user can clearly identify the predetermined place or location, and can easily locate and go to the place or location.

### PRIORITY

This application claims priority to an application entitled “MOBILE COMMUNICATION TERMINAL FOR STORING A PICTURE AND PICTURE-TAKING LOCATION INFORMATION AND METHOD FOR PROVIDING SERVICES USING THE SAME”, filed in the Korean Intellectual Property Office on Aug. 31, 2004 and assigned Serial No. 2004-69190, the entire contents of which are incorporated herein by reference.

### BACKGROUND OF THE INVENTION

1. Field of the Invention

The present invention relates generally to a mobile communication terminal, and more particularly, to a mobile communication terminal for storing a picture and picture-taking location information and a method for providing services using the picture-taking location information stored in the mobile communication terminal.

2. Description of the Related Art

After visiting a specific location, e.g., a rest area, a restaurant, or a park, etc., one may wish to visit the location again, or, perhaps, may wish to recommend the location to family or friends. However, a person may forget exactly what was enjoyable about such a location or may even forget directions to such location, etc. Further, if the location was being visited for the first time, and was difficult to locate, one may not always be able to easily recollect the exact location or directions to said location. In such a case, it may prove difficult to guide others to the location.

Accordingly, if a person takes a picture of a location and the exact location information of the location is stored in conjunction with the location, it will be far easier to direct others to the location at a later time, as occasion demands.

### SUMMARY OF THE INVENTION

Therefore, it is an object of the present invention to provide a mobile communication terminal and method for storing a picture taken at a location that a user desires to remember and picture-taking location information thereof.

It is another object of the present invention to provide a method by which a user can transmit, to other terminals, a picture and picture-taking location information, such that the location visited by the user can be introduced to others.

It is another object of the present invention to provide a method for providing a map service such that a location or place where a user took a picture can be accurately identified using the picture and picture-taking location information.

It is another object of the present invention to provide a method for providing a path guide service such that a user can easily locate and go to a location where a picture was taken using the picture and picture-taking location information.

In accordance with an aspect of the present invention, the above and other objects can be accomplished by a mobile communication terminal, including: a Global Positioning System (GPS) reception unit for receiving a GPS signal; a camera unit for taking a picture; a memory unit for storing the taken picture and picture-taking location information; and a control unit for generating the picture-taking location information using the GPS signal, and controlling an operation for storing the taken picture and the generated picture-taking location information together.

In accordance with another aspect of the present invention, the above and other objects can be accomplished by a mobile communication terminal, including: a Global Positioning System (GPS) reception unit for receiving a GPS signal; a camera unit for taking a picture; a communication unit for receiving picture-taking location information; a memory unit for storing the taken picture and the picture-taking location information; and a control unit for producing GPS satellite information using the GPS signal, controlling an operation for receiving the picture-taking location information using the produced GPS satellite information, and controlling an operation for storing the taken picture and the received picture-taking location information together in the memory unit.

In accordance with another aspect of the present invention, the above and other objects can be accomplished by a method for storing a taken picture and picture-taking location information in a mobile communication terminal, including: taking a picture; producing Global Positioning System (GPS) satellite information of a picture-taking location using a GPS signal; generating picture-taking location information using the produced GPS satellite information; and storing the taken picture and the generated picture-taking location information together.

In accordance with another aspect of the present invention, the above and other objects can be accomplished by a method for storing a taken picture and picture-taking location information in a mobile communication terminal, including: taking a picture; producing Global Positioning System (GPS) satellite information of a picture-taking location using a GPS signal; receiving picture-taking location information using the produced GPS satellite information; and storing the taken picture and the received picture-taking location information together.

In accordance with another aspect of the present invention, the above and other objects can be accomplished by a method for providing a map service in a mobile communication terminal storing a picture and picture-taking location information, including: selecting a picture from among stored pictures to receive the map service; receiving map data corresponding to picture-taking location information associated with the selected picture; and providing the map service using the received map data.

In accordance with yet another aspect of the present invention, the above and other objects can be accomplished by a method for providing a path guide service in a mobile communication terminal storing a picture and picture-taking location information, including: selecting a picture from stored pictures to receive the path guide service; measuring a current location using a Global Positioning System (GPS) signal; receiving information for guiding a path between the current location and a picture-taking location, the path guide information being generated using the measured current location and picture-taking location information associated with the selected picture; and providing the path guide service using the received path guide information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a system for providing services using a mobile communication terminal in accordance with an embodiment of the present invention;

FIG. 2 is a block diagram illustrating the mobile communication terminal in accordance with an embodiment of the present invention;

FIG. 3 is a flow chart illustrating a process for storing a picture and picture-taking location information in accordance with an embodiment of the present invention;

FIG. 4 is a table illustrating an example of storing pictures and picture-taking location information in accordance with an embodiment of the present invention;

FIG. 5 illustrates an example of a screen for displaying a picture and picture-taking location information in accordance with an embodiment of the present invention;

FIGS. 6A and 6B illustrate location services provided using a picture and picture-taking location information in accordance with an embodiment of the present invention;

FIG. 7 is a flow chart illustrating a process for providing a transmission service to transmit a picture and picture-taking location information in accordance with an embodiment of the present invention;

FIG. 8 is a flow chart illustrating a process for providing a map service using a picture and picture-taking location information in accordance with an embodiment of the present invention; and

FIG. 9 is a flow chart illustrating a process for providing a path guide service using a picture and picture-taking location information in accordance with an embodiment of the present invention.

### DETAILED DESCRIPTION OF THE PREFERRED EMBODIMENTS

Preferred embodiments of the present invention will be described in detail herein below with reference to the accompanying drawings. In the drawings, the same or similar elements are denoted by the same reference numerals even though they are depicted in different drawings.

In the following description made in conjunction with preferred embodiments of the present invention, a variety of specific elements are shown. The description of such elements has been made only for a better understanding of the present invention. Accordingly, those skilled in the art will appreciate that the present invention can be implemented without using the above-mentioned specific elements.

Additionally, in the following description, a detailed description of known functions and configurations incorporated herein will be omitted for conciseness.

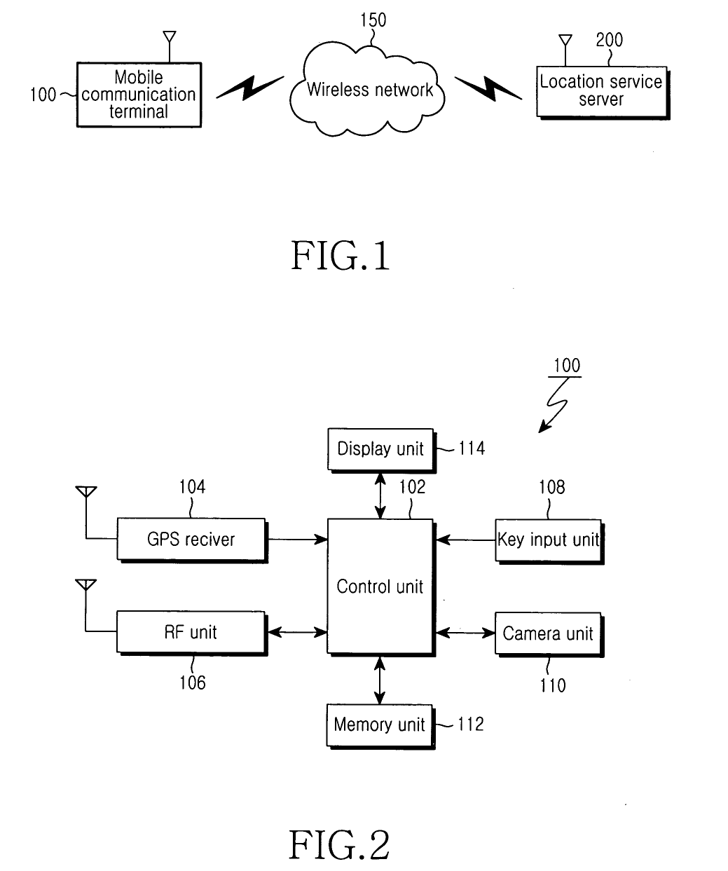

FIG. 1 is a block diagram illustrating a service system using a mobile communication terminal in accordance with an embodiment of the present invention. Referring to FIG. 1, the service system using the mobile communication terminal in accordance with the embodiment of the present invention includes a mobile communication terminal 100, a wireless network 150, a location service server 200, and a map database (not shown).

The mobile communication terminal 100 takes a picture in response to a picture-taking request signal input by a user, and produces Global Positioning System (GPS) satellite information of a picture-taking location in response to input of the picture-taking location request signal by the user. The mobile communication terminal 100 receives picture-taking location information using the GPS satellite information and stores the picture and the picture-taking location information together.

FIG. 2 is a block diagram illustrating the mobile communication terminal in accordance with an embodiment of the present invention. Referring to FIG. 2, the mobile communication terminal 100 includes a control unit 102, a GPS reception unit 104, a Radio Frequency (RF) unit 106, a key input unit 108, a camera unit 110, a memory unit 112, and a display unit 114.

The control unit 102 performs an overall control operation of the mobile communication terminal 100 in accordance with the embodiment of the present invention. More specifically, the control unit 102 controls an operation for taking a picture in response to a picture-taking request signal input by the user, and makes a request for picture-taking location information using a GPS signal in response to input of a picture-taking location information request signal. Further, the control unit 102 receives the picture-taking location information and controls an operation for storing the taken picture along with the picture-taking location information.

The GPS reception unit 104 receives the GPS signal from a GPS satellite through an antenna, processes the received GPS signal into data, and delivers the data to the control unit 102.

The RF unit 106 transmits and receives voice data and control data by radio, under control of the control unit 102. For example, the RF unit 106 can be constructed by a Code Division Multiple Access (CDMA) signal transceiver for transmitting and receiving a CDMA radio signal, and a CDMA modem for processing the voice and control data to transmit and receive the CDMA radio signal.

The key input unit 108 is used for interfacing with the user, and includes a plurality of keys such as various function keys, digit keys, special keys, etc. The key input unit 108 outputs a key input signal corresponding to a key pressed by the user. More specifically, the key input unit 108 includes a picture-taking key, a picture-taking location information request key, etc. The key input unit 108 outputs a corresponding input signal when the user presses a key.

The camera unit 110 takes a picture of an object under control of the control unit 102, outputs a picture signal according to a picture taking operation, and generates screen data for displaying the picture signal.

The memory unit 112 temporarily stores data processed in the control unit 102, or provides the stored data to the control unit 102. The memory unit 112 can be constructed by a Read Only Memory (ROM) for storing an operation program, an Electrically-Erasable Programmable Read-Only Memory (EEPROM), a Random Access Memory (RAM), etc. The memory unit 112 stores the taken picture and the picture-taking location information in accordance with the embodiment of the present invention.

The display unit 114, for example, a Liquid Crystal Display (LCD), outputs various display data generated from the terminal. Moreover, the display unit 114 displays the picture taken by the camera unit 110 and displays the picture-taking location information.

The mobile communication terminal described above, in accordance with the embodiment of the present invention, can transmit a picture and picture-taking location information to another terminal, such that the user can introduce a visited place to others. Moreover, the mobile communication terminal 100 transmits the stored picture and picture-taking location information to the location service server 200, thereby receiving a map service or a path guide service associated with the picture from the location service server 200.

Referring again to FIG. 1, the wireless network 150 can be a CDMA network, a Global System for Mobile Communications (GSM) network, etc., and provides a radio signal transmission/reception path between the mobile communication terminal 100 and the location service server 200.

The location service server 200 receives GPS satellite information from the mobile communication terminal 100 through the wireless network 150, generates picture-taking location information using the received GPS satellite information, and transmits the generated picture-taking location information to the mobile communication terminal 100. The picture-taking location information transmitted to the mobile communication terminal 100 can be composed of a simple numerical value or characters. The location service server 200 receives a predetermined picture and picture-taking location information from the mobile communication terminal 100, and provides a map service or a path guide service corresponding to the picture and the picture-taking location information to the mobile communication terminal 100.

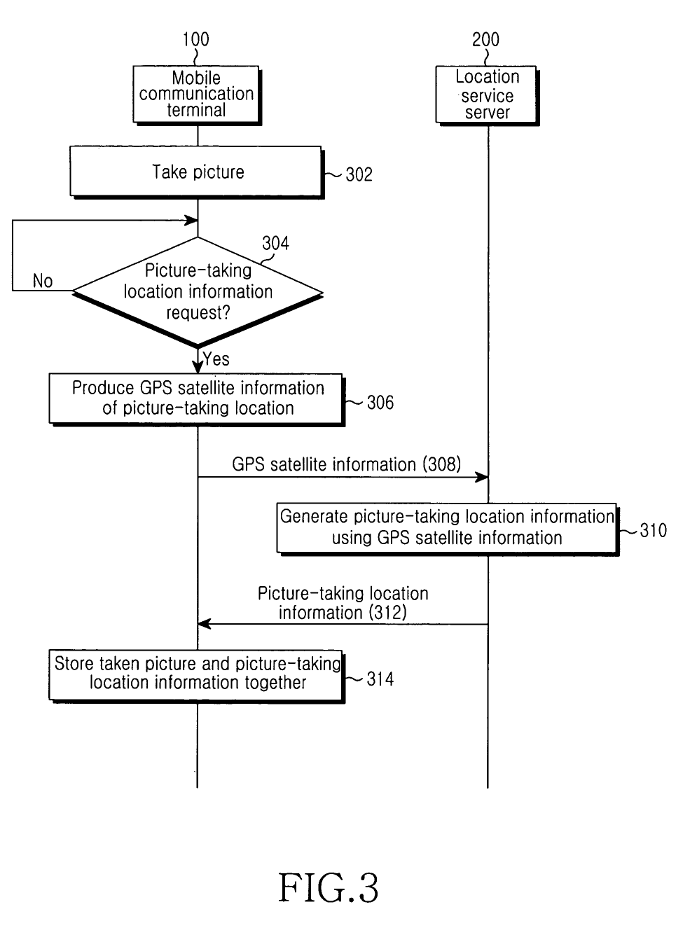

FIG. 3 is a flow chart illustrating a process for storing a picture and picture-taking location information in the mobile communication terminal 100 in accordance with an embodiment of the present invention. Referring to FIG. 3, the mobile communication terminal 100 takes a picture by means of the camera unit 110 in response to a picture-taking request signal input by the user in step 302. The mobile communication terminal 100 determines if a location information request signal associated with the picture has been input by the user in step 304. If the location information request signal associated with the picture has been input, the mobile communication terminal 100 calculates the timing for each satellite and produces GPS satellite information of a picture-taking location, using a GPS signal received through the GPS reception unit 104 in step 306. Subsequently, the mobile communication terminal 100 transmits the produced GPS satellite information to the location service server 200 through the wireless network 150 in step 308.

The location service server 200 generates picture-taking location information using the GPS satellite information received from the mobile communication terminal 100 in step 310. The location service server 200 transmits the generated picture-taking location information to the mobile communication terminal 100 in step 312. The picture-taking location information transmitted to the mobile communication terminal 100 can include a simple numerical value, characters, or coordinates.

The mobile communication terminal 100 receives the picture-taking location information from the location service server 200, and stores the taken picture along with the picture-taking location information in the memory unit 112 in step 314. The mobile communication terminal 100 receives a GPS satellite signal to directly generate the location information without making use of the location service server 200. Alternatively, the mobile communication terminal 100 can receive the location information from an external unit connected thereto and store the received location information along with the picture.

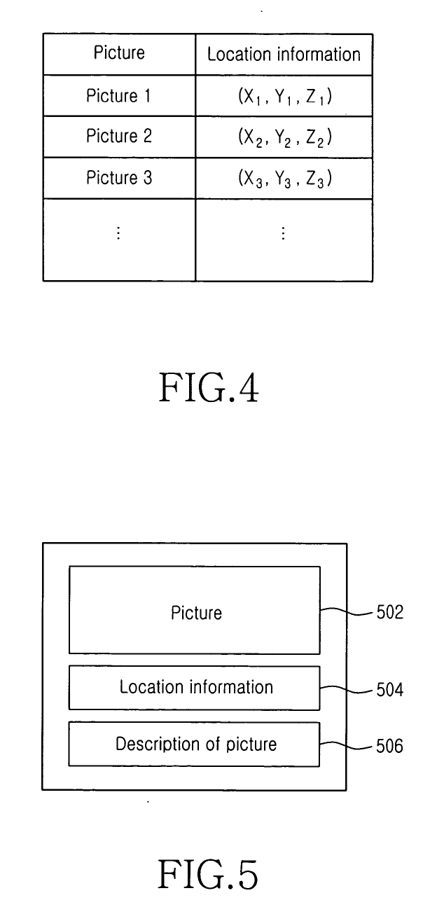

FIG. 4 is a table illustrating an example of storing pictures and picture-taking location information in accordance with an embodiment of the present invention. Referring to FIG. 4, location information associated with taken pictures, for example, Picture 1, Picture 2, Picture 3, etc., can be expressed by location coordinates such as, for example, (X₁,Y₁,Z₁), (X₂,Y₂,Z₂), (X₃,Y₃,Z₃), etc.

The mobile communication terminal 100 can configure a screen for displaying the pictures and the picture-taking location information stored in the memory unit 112 through an interface with the user.

FIG. 5 illustrates an example of a screen for displaying a picture and picture-taking location information in accordance with an embodiment of the present invention. Referring to FIG. 5, the screen for displaying a picture and picture-taking location information can be configured by a picture area 502 for displaying the picture, a location information area 504 for displaying the picture-taking location information, and a description area 506 for displaying a description of the picture. The mobile communication terminal 100 can edit and store the screen for displaying the picture and the picture-taking location information through an interface with the user. This screen provides information associated with a picture in more detail.

In accordance with an embodiment of the present invention, various services can be provided to the user of the mobile communication terminal using stored pictures and picture-taking location information.

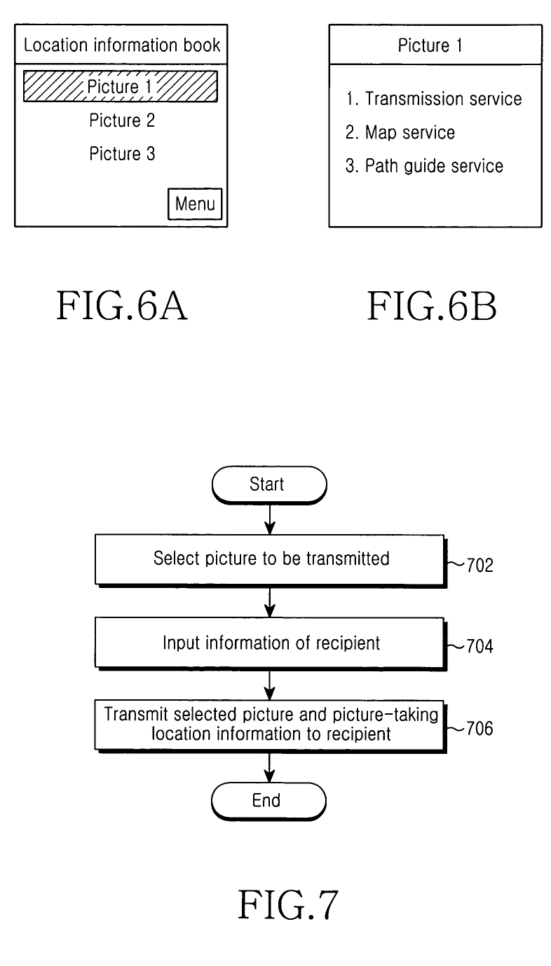

FIGS. 6A and 6B illustrate services provided using a picture and picture-taking location information in accordance with an embodiment of the present invention. More specifically, FIG. 6A illustrates a location information book screen for displaying stored pictures and picture-taking location information, and FIG. 6B illustrates services capable of being provided using a stored picture and picture-taking location information. When a predetermined picture (e.g., Picture 1) is selected from the location information book screen as illustrated in FIG. 6A, the mobile communication terminal 100 displays a list of services capable of being provided using the selected picture (Picture 1) and picture-taking location information associated with the selected picture as illustrated in FIG. 6B. For example, the services capable of being provided using the picture and the picture-taking location information can include a transmission service, a map service, a path guide service, etc.

First, the transmission service is a service by which the user can transmit, to another terminal, the stored picture and picture-taking location information to introduce a visited location to another user. Second, the map service is a service by which the user can download a map corresponding to the stored picture and picture-taking location information. Third, the path guide service is a service by which the user can receive path guide information corresponding to the stored picture and picture-taking location information.

FIG. 7 is a flow chart illustrating a process for transmitting a picture and picture-taking location information in accordance with the embodiment of the present invention. Referring to FIG. 7, the mobile communication terminal 100 selects a picture to be transmitted to another user from among pictures stored in advance through an interface with the user in step 702. Subsequently, the mobile communication terminal 100 receives information of a recipient to receive the selected picture from the user in step 704. Subsequently, the mobile communication terminal 100 transmits, to the recipient, the selected picture and picture-taking location information corresponding thereto in step 706. The picture and the picture-taking location information are configured and transmitted in the form of a display screen illustrated in FIG. 5.

The recipient can be another terminal or can be located on the Internet. For example, when the recipient is another terminal, a user of another terminal can also receive location services using the received picture and picture-taking location information. Further, when the recipient is located on the Internet, the mobile communication terminal 100 uploads the selected picture along with the picture-taking location information to a predetermined address on the Internet such that many people can utilize the picture and the picture-taking location information.

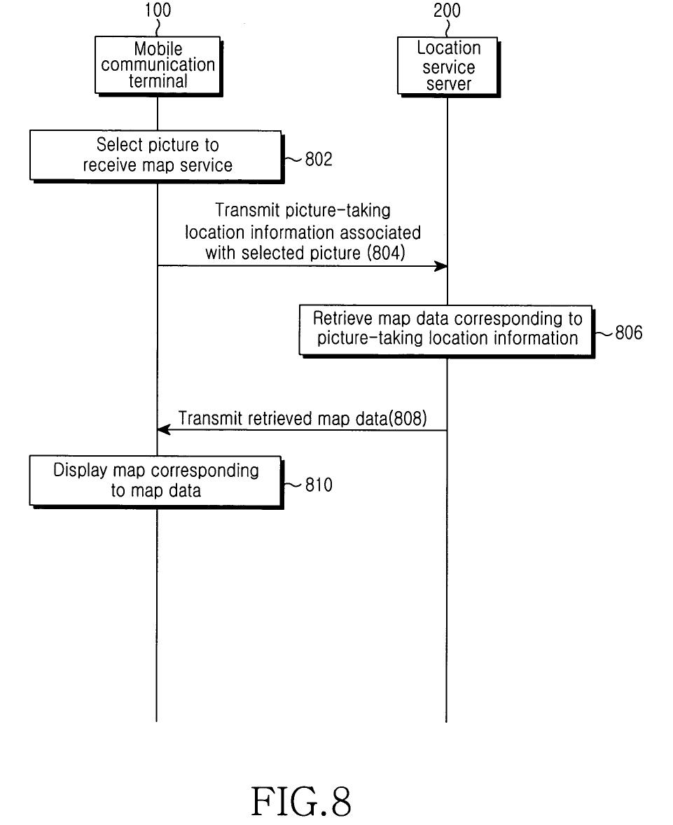

FIG. 8 is a flow chart illustrating a process for providing the map service using a picture and picture-taking location information in accordance with the embodiment of the present invention. Referring to FIG. 8, the mobile communication terminal 100 selects a picture from among pictures stored in advance to receive the map service through an interface with the user in step 802. The mobile communication terminal 100 transmits picture-taking location information associated with the selected picture to the location service server 200 to receive the map service in step 804. The location service server 200 retrieves map data corresponding to the picture-taking location information received from the mobile communication terminal 100 in step 806. Subsequently, the location service server 200 transmits the retrieved map data in step 808.

The mobile communication terminal 100 displays a map associated with the selected picture using the map data received from the location service server 200 in step 810. The map service can be received through an external unit connected with the mobile communication terminal 100 as well as through the location service server 200. That is, the map data can be received through a navigator storing map information.

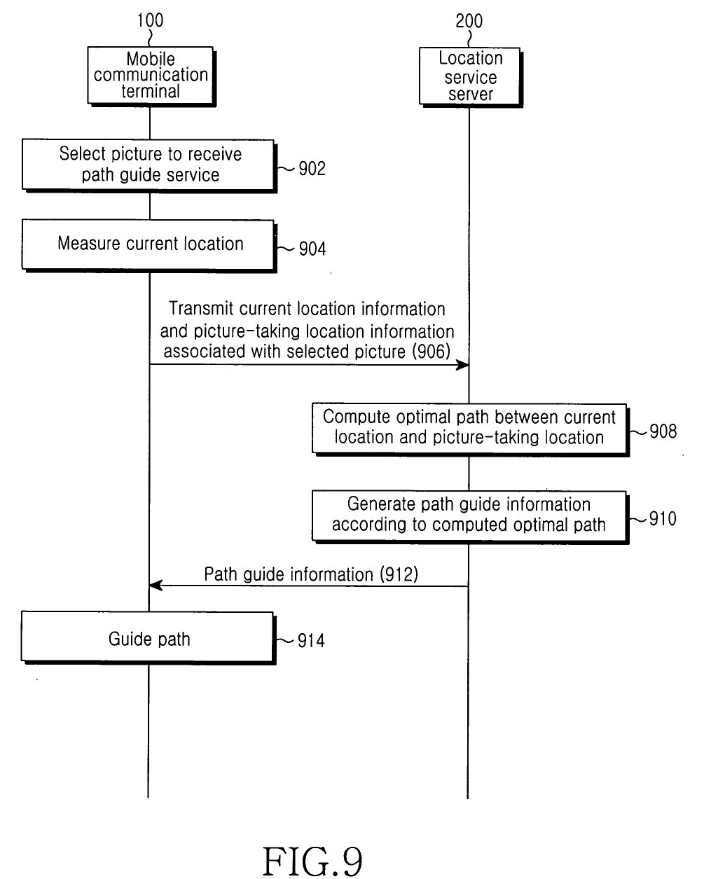

FIG. 9 is a flow chart illustrating a process for providing the path guide service using a picture and picture-taking location information in accordance with the embodiment of the present invention. Referring to FIG. 9, the mobile communication terminal 100 selects a picture from among pictures stored in advance to receive the path guide service through an interface with the user in step 902. The mobile communication terminal 100 measures a current location to receive the path guide service using a GPS signal in step 904. Subsequently, the mobile communication terminal 100 transmits current location information and picture-taking location information associated with the selected picture to the location service server 200 to receive the path guide service in step 906.

The location service server 200 computes an optimal path between locations corresponding to the current location information and the picture-taking location information received from the mobile communication terminal 100 in step 908. The location service server 200 generates path guide information to guide a path between the current location and the picture-taking location in step 910. The location service server 200 transmits the path guide information for guiding the path between the current location and the picture-taking location to the mobile communication terminal 100 in step 912.

The mobile communication terminal 100 guides the path between the current location and the picture-taking location using the path guide information in step 914. The path guide service can be received through an external unit connected with the mobile communication terminal 100 as well as through the location service server 200. That is, optimal path data can be received through a navigator capable of computing a path.

As described above, the mobile communication terminal stores a picture of a predetermined place, e.g., a famous park, temple, etc., and picture-taking location information in accordance with the present invention, such that the user can clearly identify the predetermined place or location, and can easily locate and go to the place or location. Because the picture and the picture-taking location information stored in the mobile communication terminal can be transmitted to others or uploaded to the Internet in accordance with the present invention, the picture-taking location can be introduced to others in detail. Further, because a map service or a path guide service based on a picture of a predetermined place or location and picture-taking location information stored in the mobile communication terminal can be provided in accordance with the present invention, the user can easily locate and go to the place or location while viewing a map.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A mobile communication terminal, comprising:
a Global Positioning System (GPS) reception unit for receiving a GPS signal;
a camera unit for taking a picture;
a memory unit for storing the taken picture and picture-taking location information; and
a control unit for generating the picture-taking location information using the GPS signal, and controlling an operation for storing the taken picture and the generated picture-taking location information together.

2. The mobile communication terminal of claim 1, wherein the picture-taking location information is coordinates of a location where the picture is taken.

3. A mobile communication terminal, comprising:
a Global Positioning System (GPS) reception unit for receiving a GPS signal;
a camera unit for taking a picture;
a communication unit for receiving picture-taking location information;
a memory unit for storing the taken picture and the picture-taking location information; and
a control unit for producing GPS satellite information using the GPS signal, controlling an operation for receiving the picture-taking location information using the produced GPS satellite information, and controlling an operation for storing the taken picture and the received picture-taking location information together in the memory unit.

4. The mobile communication terminal of claim 3, wherein the communication unit receives the picture-taking location information from a location service server for providing a location service.

5. The mobile communication terminal of claim 3, wherein the communication unit receives the picture-taking location information from an external unit connected to the mobile communication terminal.

6. The mobile communication terminal of claim 3, wherein the picture-taking location information is coordinates of a location where the picture is taken.

7. A method for storing a taken picture and picture-taking location information in a mobile communication terminal, comprising:
taking a picture;
producing Global Positioning System (GPS) satellite information of a picture-taking location using a GPS signal;
generating picture-taking location information using the produced GPS satellite information; and
storing the taken picture and the generated picture-taking location information together.

8. The method of claim 7, wherein the picture-taking location information is coordinates of a location where the picture is taken.

9. A method for storing a taken picture and picture-taking location information in a mobile communication terminal, comprising:
taking a picture;
producing Global Positioning System (GPS) satellite information of a picture-taking location using a GPS signal;
receiving picture-taking location information using the produced GPS satellite information; and
storing the taken picture and the received picture-taking location information together.

10. The method of claim 9, wherein the mobile communication terminal receives the picture-taking location information from a location service server.

11. The method of claim 10, wherein the mobile communication terminal receives the picture-taking location information from an external unit connected thereto.

12. The method of claim 9, wherein the picture-taking location information is coordinates of a location where the picture is taken.

13. The method of claim 9, further comprising:
transmitting the taken picture and the picture-taking location information to another mobile communication terminal.

14. The method of claim 9, further comprising:
uploading the taken picture and the picture-taking location information to a predetermined address on the Internet.

15. The method of claim 9, further comprising:
transferring the taken picture and the picture-taking location information to an external unit connected to the mobile communication terminal.

16. A method for providing a map service in a mobile communication terminal for storing a picture and picture-taking location information, comprising:
selecting a picture from stored pictures;
receiving map data corresponding to picture-taking location information associated with the selected picture; and
providing the map service using the received map data.

17. A method for providing a path guide service in a mobile communication terminal that stores a picture and picture-taking location information, comprising:
selecting a picture from stored pictures;
determining a current location using a Global Positioning System (GPS) signal;
receiving information for guiding a path between the current location and a picture-taking location, the path guide information being generated using the determined current location and picture-taking location information associated with the selected picture; and
providing the path guide service using the received path guide information.
